(19) United States
(12) Patent Application Publication
(10) Pub. No.: US 2005/0263443 A1
(43) Pub. Date: Dec. 1, 2005

(54) Method and apparatus for inspecting containers

(76) Inventors: William R. Martin, Slippery Rock, PA (US); Timothy Mclntosh, Pittsburgh, PA (US); Gregory A. Ritz, Berkey, OH (US); Noel D. Wendt, Toledo, OH (US)

Correspondence Address: OWENS-ILLINOIS, INC., ONE SEAGATE, 25-LDP, TOLEDO, OH, 43666, US

(21) Appl. No.: 10/856,517

(22) Filed: May 28, 2004

(51) Int. Cl. B07C 5/00

(52) U.S. Cl. 209/522

(57) ABSTRACT

A method and apparatus for inspecting containers including a plurality of container inspection devices disposed along an inspection path directs a plurality of test containers having known characteristics through the inspection path so that the test containers can be inspected at each of the container inspection devices to obtain information indicative of the characteristics found in the test containers, and correlates that information with the known characteristics in the containers. The apparatus preferably includes a test container conveyor loop connected at one end to the inspection path upstream of the inspection devices, and at its other end to the conveyor path downstream of the inspection devices. A controller preferably automates a test cycle to provide test containers in the inspection path, receive from the inspection devices information relating to characteristics detected in the test containers, and return the test containers from the inspection path to the test container conveyor loop.

### FIELD OF THE INVENTION

This invention relates generally to the manufacture of containers and more particularly to a method and apparatus for inspecting containers.

### BACKGROUND OF THE INVENTION

In the manufacture of glassware, such as glass containers, various anomalies or variations can occur that affect commercial desirability of the containers. These anomalies, termed “commercial variations,” can involve dimensional characteristics of the container such as the container finish, surface characteristics that can affect acceptable operation of the container, such as surface variations at the container sealing surface, or variations such as stones or checks within the container finish, sidewall or bottom.

It is conventional practice to mold indicia on each container indicative of the mold of origin of the container for inspection and quality control purposes. Some container inspection systems utilize a starwheel-type conveyor for accepting containers in sequence from a feed conveyor and transporting the containers through a series of inspection stations. One or more inspections may take place for each container at each station of the apparatus. The term “inspection” is used in its broadest sense to encompass any optical, electro-optical, mechanical or electrical observation or engagement with the container to measure or determine a potentially variable characteristic, including but not necessarily limited to mold codes and commercial variations.

To verify the accuracy and reliability of the inspection apparatus, containers having known commercial variations have been manually fed through the inspection apparatus by an operator. As these containers with known commercial variations pass through the inspection apparatus, the operator could determine if the inspection apparatus identified the known commercial variations. After the containers with the known commercial variations were discharged from the inspection apparatus, the operator would manually retrieve each of the containers to prevent them from proceeding downstream with other containers that have passed inspection. Manually feeding, monitoring and retrieving the sample containers increases down time of the inspection apparatus and is inefficient.

### SUMMARY OF THE INVENTION

A method and apparatus for inspecting containers including a plurality of container inspection devices disposed along an inspection path direct a plurality of test containers having known characteristics, preferably including at least commercial variations, through the inspection path so that the test containers can be inspected at each of the container inspection devices to obtain information indicative of the characteristics found in the test containers, and correlate that information with the known characteristics in the containers. The apparatus preferably includes a test container conveyor loop connected at one end to the inspection path upstream of the inspection devices, and at its other end to the conveyor path downstream of the inspection devices. A controller preferably substantially automates a test cycle to provide test containers in the inspection path, receive from the inspection devices information relating to the characteristics detected in the test containers, and return the test containers from the inspection path to the test container conveyor loop.

In one presently preferred embodiment, diverters at each end of the test container conveyor loop direct containers from the test container conveyor loop into the inspection path upstream of the inspection devices, and after inspection, direct the containers from the inspection path back onto the test container conveyor loop. A controller preferably operates the diverters to selectively permit containers on the test container conveyor loop to enter the inspection path, monitors the output of the inspection devices, and correlates the output of the inspection devices with the known characteristics of the test containers to help determine the accuracy of the inspection devices.

The controller may also monitor, be responsive to, and control a conveyor that feeds containers to the inspection path, a reject mechanism downstream of the inspection path to remove containers that did not pass inspection, and an outfeed conveyor which carries containers away from the inspection path. In this manner, the controller can automatically stop the infeed conveyor, start the test container conveyor to feed test containers into the inspection path, disable the reject mechanism to prevent test containers from being rejected, and divert containers from the inspection path back onto the test container conveyor. This process may be manually instituted by an operator, or may be automatically instituted by the controller at set intervals as desired to verify the operation of the container inspection devices.

### BRIEF DESCRIPTION OF THE DRAWINGS

These and other objects, features and advantages of the present invention will be apparent from the following detailed description of the preferred embodiments, appended claims and accompanying drawings in which:

FIG. 1 is a schematic view of one presently preferred embodiment of a container inspection apparatus including a test container conveyor in parallel with an inspection path of an inspection apparatus including a plurality of inspection stations, and a controller that monitors and controls the operation of the devices associated with the inspection path and with the test container conveyor; and

FIG. 2 is a schematic view of a second presently preferred embodiment of a container inspection apparatus including a test container conveyor loop in parallel with an inspection path.

### DETAILED DESCRIPTION OF THE PREFERRED EMBODIMENTS

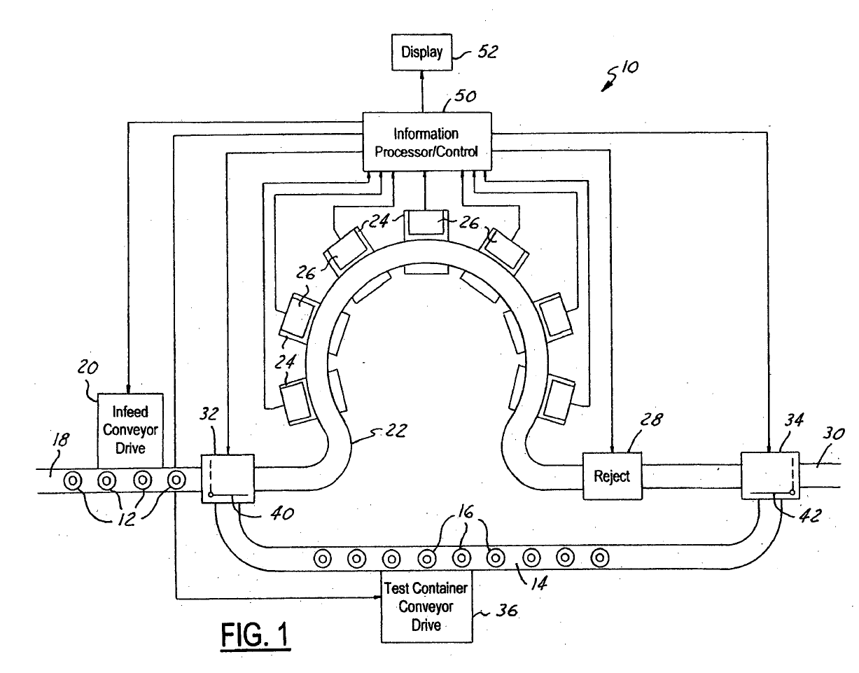

Referring in more detail to the drawing, FIG. 1 illustrates a container inspection apparatus 10 used to inspect production containers 12 for certain characteristics typically including commercial variations and mold indicia, remove from the container supply those containers which have unacceptable commercial variations, and permit the remaining containers to pass downstream of the inspection apparatus 10 for further processing. To test and verify correct operation of the container inspection apparatus 10, a test container conveyor loop 14 is provided to send a plurality of test containers 16 having known characteristics, preferably including at least commercial variations, through the inspection apparatus 10. The output from the container inspection apparatus 10 relating to inspection of the test containers 16 can be compared to the known characteristics of the test containers 16 to determine if the inspection apparatus 10 properly identifies the known characteristics of the test containers 16.

The container inspection apparatus 10 includes an infeed conveyor 18 having a drive mechanism 20, such as an electric motor, that supplies production containers 12 to an inspection conveyor or inspection path 22 passing by or through a plurality of inspection stations 24. The inspection path 22 may include a rotary starwheel type conveyor to move containers through angularly spaced inspection stations 24, or any other arrangement including a linear conveyor and in-line inspection stations. At each inspection station 24 one or more inspection devices 26 are provided to inspect one or more characteristics of each container, and provide an output indicative of the information obtained from the inspection. The inspection path 22 leads to a reject mechanism 28 that removes from the inspection path 22 those containers that did not pass one or more inspections. Containers that passed all inspections are permitted to pass by the reject mechanism 28 to an outfeed conveyor 30 for transfer to subsequent processing stations. In one presently preferred implementation, the container inspection apparatus is constructed and arranged as disclosed in U.S. Pat. No. 6,581,751, the disclosure of which is incorporated herein by reference in its entirety. The invention also can be implemented in non-loop-type inspection systems, such as the linear inspection system shown in U.S. Pat. No. 6,172,355.

To verify the operation of the inspection devices, the test container conveyor loop 14 is disposed in parallel with the inspection path 22 to selectively provide a plurality of test containers 16 having known characteristics, such as commercial variations, mold indicia or other inspected feature or aspect, into the inspection path 22. (It will be appreciated that the term “parallel,” when referring to conveyor 14, is used in the functional sense in that conveyor 14 receives containers from a point downstream of at least a portion of inspection path 22 and returns the containers to another point upstream of at least a portion to the inspection path. The term “parallel” is not used in the geometric sense that any portion of conveyor 14 is necessarily extending in the same direction as and equidistant from path 22.) The test container conveyor 14 is operably connected with the inspection path 22 upstream of the inspection stations 24 through an infeed gate 32 at one end of the test container conveyor 14, and at the other end of the test container conveyor 14 through an outfeed gate 34 downstream of the inspection stations 24 to permit retrieval of test containers 16 that have passed through the inspection apparatus 10. The test container conveyor 14 includes a drive mechanism 36, such as an electric motor, which is selectively operable to drive the conveyer 14 only when needed to provide test containers 16 into the inspection path 22 and retrieve test containers 16 from the inspection path 22.

The infeed gate 32 preferably includes a diverter 40 moveable between first and second positions. In its first position (shown in solid line in FIG. 1), the diverter 40 permits production containers 12 from the infeed conveyor 18 to pass through the infeed gate 32 into the inspection path 22, and prevents test containers 16 from the test container conveyor 14 to pass through the infeed gate 32. In its second position (shown in dashed line in FIG. 1), the diverter 40 prevents production containers 12 on the infeed conveyer 18 from reaching the inspection path 22, and permits the test containers 16 on the test container conveyer 14 to pass through the infeed gate 32 to the inspection path 22. Likewise, the outfeed gate 34 includes a diverter 42 movable between first and second positions. In its first position (shown in solid line in FIG. 1), the diverter 42 at the outfeed gate 34 permits production containers 12 from the inspection path 22 to pass through the outfeed gate 34 to the outfeed conveyor 30 and prevents production containers 12 in the inspection path 22 from passing to the test container conveyer 14. In its second position (shown in dashed line in FIG. 1), the diverter 42 at the outfeed gate 34 prevents test containers 16 from passing from the inspection path 22 to the outfeed conveyor 30, and directs those containers to the test container conveyor 14. At least the diverter 40 may not be needed since the infeed and test container conveyors are controllable to prevent containers from being sent to the inspection path erroneously, and the infeed gate 32 can be constructed to guide production containers 12 to the inspection path 22 and not to the test containers conveyor 14, and also to guide test containers 16 to the inspection path 22 and not to the infeed conveyor 18.

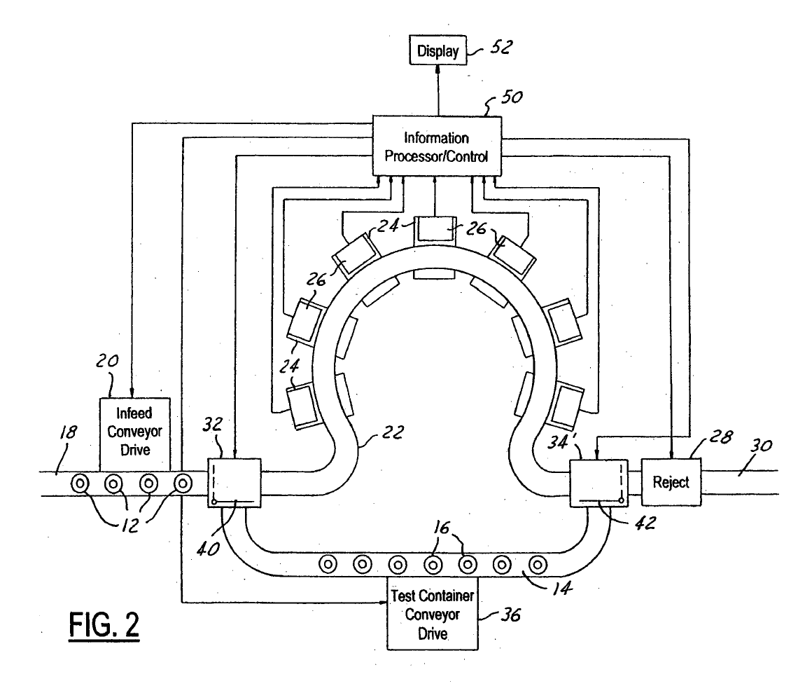

In the embodiment shown in FIG. 1, the reject mechanism 28 is also preferably selectively operated only when production containers 12 are passing through the inspection path 22. When the test containers 16 are passing through the inspection path 22 the reject mechanism 28 is preferably disabled or turned off so that the test containers 16 are not rejected and may pass to the outfeed gate 34 and back onto the test container conveyer 14 for a subsequent test cycle. Alternatively, as shown in FIG. 2 the outfeed gate 34′ can be disposed upstream of the reject mechanism 28 so that test containers 16 are diverted back to the test container conveyor 14 without having to pass by or through the reject mechanism 28, thereby obviating the need to disable the reject mechanism 28.

An inspection system controller 50 and information processor communicates with the inspection devices 26 to receive and process information obtained from the inspection devices 26 as containers are inspected, and selectively controls the infeed conveyor drive 20, test container conveyor drive 36, infeed and outfeed gates 32, 34 (diverters 40, 42), and the reject mechanism 28. During inspection of production containers 12, the infeed conveyor drive 20 is activated to advance production containers 12 on the infeed conveyor 18 toward the inspection path 22. The infeed gate diverter 40 is disposed in its first position permitting production containers 12 on the infeed conveyor 18 to pass through the infeed gate 32 to the inspection path 22. The reject mechanism 28 is activated so that production containers 12 which do not pass inspection may be rejected and removed from the stream or supply of containers. The outfeed gate diverter 42 is disposed in its first position permitting production containers 12 that pass the reject mechanism 28 to proceed to the outfeed conveyor 30.

During the inspection of the production containers 12, the inspection system controller 50 receives and process information from the inspection devices 26 to, among other things, determine if a production container 12 has commercial variations falling outside of predetermined limits, preferably programmed or otherwise recorded in or accessible by the controller. If the controller 50 detects or determines that a production container 12 has commercial variations falling outside of the predetermined limits, the controller 50 sends a signal to the reject mechanism 28 to cause the reject mechanism 28 to remove that container from the inspection path so that the container does not reach the outfeed conveyor 30 and is not transported to downstream processing stations.

When it is desired to initiate a test container challenge of the inspection apparatus 10, to determine if the inspection devices 26 are functioning properly, an operator can manually initiate a test cycle, an operator can initiate a test cycle through the controller 50, or the controller 56 can automatically initiate a test cycle at set intervals or randomly, at desired. To conduct a test cycle of the container inspection apparatus 10, the infeed conveyor drive 20 is deactivated to prevent production containers 12 from reaching the inspection path 22. The infeed gate diverter 40 is moved to its second position, the reject mechanism 28 is disabled or turned off, the outfeed gate diverter 42 is moved to its second position, and the test container conveyor drive 36 is activated to advance the test container conveyor 14 and move test containers 16 thereon through the infeed gate 32 and into the inspection path 22. Again, all of these steps can be performed manually by the operator, or, more preferably, by the controller 50 either at the operators direction or without operator intervention as determined by the controller 50.

During a test cycle, test containers 16 from the test container conveyor 14 are moved through the infeed gate 32 and into the inspection path 22 where the test containers 16 pass through the inspection stations 24 for inspection by the inspection devices 26. Information obtained from the inspections is fed from the inspection devices 26 to the controller 50. The test containers 16 pass through the reject mechanism 28 which is disabled, and are directed back onto the test container conveyor 14 by the diverter 42 at the outfeed gate 34. The controller 50 receives, and preferably processes and displays the information obtained from the inspection devices 26 which is preferably indicative of at least the commercial variations detected by the inspection devices 26 during that test cycle. Either the operator, the controller 50, or both, correlate the information received from the inspection devices 26 with the known commercial variations of the test containers 16 to determine if the inspection apparatus 10 is operating satisfactorily. The controller 50 may have information relating to each test container programmed or otherwise recorded in or accessible by the controller 50 so that the controller can compare the known commercial variations with those detected during a particular test cycle.

When the test cycle is complete and it is desired to resume inspection of production containers, the infeed gate diverter 40 is moved to its first position, the infeed conveyor drive 20 is turned on, the reject mechanism 28 is turned on, the outfeed diverter 42 is moved to its first position, and the test container conveyor drive 32 is deactivated. Production containers 12 on the infeed conveyor 18 are fed through the infeed gate 32 into the inspection path 22, pass through the reject mechanism 28 if the production containers 12 passed inspection, and thereafter pass through the outfeed gate 34 and onto the outfeed conveyor 30. With the test container conveyor drive 36 deactivated, the test containers 16 are not advanced towards the inspection path 22.

Desirably, since the test cycle can be initiated through the controller 50, an operator remote from the location of the container testing apparatus 10 can initiate a test cycle by instructing the controller 50 to do so. The controller 50 preferably has an output that provides information to a display 52 for an operator, who can but need not be remote from the inspection apparatus, so that the operator can monitor the results of the test cycle. Desirably, the information processed by the controller 50 during inspection of production containers 12 as well as during a test cycle, can be communicated by the controller 50 to a display or other receiver anywhere in the world via the internet or other preferably real-time connection permitting remote monitoring of the container inspection apparatus 10. Likewise, a signal can be provided to the controller 50 from remote locations to initiate a test cycle, or for other operative control of the controller and inspection apparatus.

Those of ordinary skill in the art will recognize that the preceding description of preferred embodiments of the invention is provided in terms of description, and not limitation. Modifications and substitutions can be made without departing from the spirit and broad scope of the invention, as set forth in the appended claims. For example, without limitation, the controller may also selectively operate a drive mechanism for the outfeed conveyor to turn off the outfeed conveyor during a test cycle, since during a test cycle containers are not fed to the outfeed conveyor. Of course, still other modifications and substitutions may be made to the presently preferred embodiment of the test container apparatus and the container testing method set forth herein.

1. A method of verifying operation of a plurality of container inspection devices that inspect containers traveling in an inspection path through said devices, said method including the steps of:
(a) directing a plurality of test containers having known characteristics from a secondary path through said inspection path,
(b) inspecting said test containers with at least some of said devices to obtain information indicative of characteristics found in the test containers, and
(c) correlating the information obtained in said step (b) with the known characteristics in the containers.

2. The method set forth in claim 1 wherein the test containers are disposed in a loop parallel to said path, and wherein said step (a) is accomplished by interrupting a flow of containers traveling in said inspection path, and directing said test containers from said loop onto said inspection path and then back into said loop.

3. The method set forth in claim 2 wherein the inspection path includes a reject mechanism and said reject mechanism is disabled to prevent test containers from being processed as rejected containers.

4. The method set forth in claim 2 wherein said loop includes a test container conveyor that communicates at one end with an infeed gate and at its other end with an outfeed gate, and a controller controls the operation of the test container conveyor and the outfeed gate, said step of directing a plurality of test containers through said inspection path includes controlling said test container conveyor to send test containers to said infeed gate and controlling said outfeed gate to permit test containers in the inspection path to be moved back onto said test container conveyor.

5. The method set forth in claim 4 wherein said outfeed gate includes a diverter movable between a first position wherein it directs containers away from said test container conveyor and a second position wherein it directs containers toward said test container conveyor and said step of controlling said outfeed gate includes providing a signal from the controller to the diverter to move the diverter between its first and second positions.

6. The method set forth in claim 4 wherein said correlating step is performed at least in part by the controller.

7. The method of claim 6 wherein said controller communicates with each of said container inspection devices to receive information from said container inspection devices, and said correlating step includes processing and comparing the information obtained from the container inspection devices with the known characteristics.

8. The method of claim 6 wherein said controller communicates with each of said container inspection devices to receive information from said container inspection devices, and said correlating step includes displaying the information obtained from the container inspection devices so that said information can be compared with the known characteristics.

9. The method of claim 6 wherein said known characteristics of said test containers are accessible by the controller and said step of correlating information includes directly comparing the known characteristics for individual test containers with the information obtained through said step of inspecting said test containers.

10. The method of claim 9 wherein said known characteristics of said test containers are programmed into said controller and said comparing step is accomplished by correlating the information received from inspecting the test containers with the programmed known characteristics.

11. The method of claim 10 wherein correlating the information received from inspecting the test containers with the programmed known characteristics includes the step of providing both the information received from inspecting the containers and the programmed known characteristics to a display for viewing by an operator.

12. The method set forth in claim 4 wherein said loop includes an infeed gate at an end of the test container conveyor through which test containers are fed to the inspection path, and said step of directing a plurality of test containers through said inspection path includes controlling said infeed gate to permit test containers to pass through the infeed gate and enter the inspection path.

13. The method set forth in claim 12 wherein said infeed gate includes a diverter movable in response to a signal between a first position wherein it does not permit test containers to reach the inspection path and a second position wherein it permits the flow of containers from said test container conveyor into said inspection path, and said step of controlling said infeed gate includes providing a signal from the controller to the diverter to move the diverter between its first and second positions.

14. The method set forth in claim 2 wherein the inspection path communicates with an infeed conveyor by which production containers are fed to the inspection path, and the loop includes a test container conveyor by which test containers are fed to the inspection path during a test cycle, and said step (a) is accomplished by stopping the infeed conveyor to prevent production containers from flowing to the inspection path, and starting the test container conveyor to provide test containers to the inspection path and receive containers on the test container conveyor from the inspection path after said step of inspecting said test containers.

15. The method of claim 14 wherein the inspection devices include a controller and said steps of stopping the infeed conveyor and starting the test container conveyor are performed by the controller.

16. The method of claim 1 wherein said characteristics include at least one of commercial variations and mold indicia.

17. Apparatus for inspecting containers for characteristics which includes:
at least one inspection station disposed in an inspection path,
conveyors for feeding containers to and from said inspection path,
a test container conveyor loop parallel to said path and connected at one end with said inspection path upstream of said at least one inspection station and at its other end with said inspection path downstream of said at least one inspection station,
a plurality of test containers in said loop having known characteristics, and
a controller operable to selectively interrupt flow of containers between said conveyors and said path, direct said test containers from said loop through said path and back into said loop, and monitor outputs of said at least one inspection station during flow of said test containers through said stations.

18. The apparatus of claim 17 which also includes an infeed gate connecting said one end of said loop with said inspection path and an outfeed gate connecting said other end of said loop with said inspection path, said infeed gate and said outfeed gate being operated by said controller to selectively direct containers from said loop onto said inspection path and from said inspection path back onto said loop during a test cycle.

19. The apparatus of claim 18 wherein said infeed gate includes a diverter movable between a first position wherein it does not interrupt the flow of containers in said inspection path and a second position wherein it interrupts the flow of containers in said inspection path and permits the flow of containers from said test container conveyor loop into said inspection path.

20. The apparatus of claim 18 wherein said outfeed gate includes a diverter movable between a first position wherein it does not interrupt the flow of containers from said inspection path to an outfeed conveyor carrying containers away from said inspection path and a second position wherein it prevents the flow of containers from said inspection path to said outfeed conveyor and permits the flow of containers from said inspection path to said test container conveyor loop.

21. The apparatus of claim 17 which also includes a test container conveyor drive selectively operated by said controller to move test containers toward said inspection path when a test cycle is initiated and deactivated by the controller when a test cycle is complete.

22. The apparatus of claim 17 wherein said conveyors for feeding containers include an infeed conveyor that feeds containers to the inspection path and an infeed conveyor drive, said infeed conveyor drive being selectively disabled by the controller to prevent sending containers from the infeed conveyor to the inspection path during a test cycle.

23. The apparatus of claim 17 wherein the controller is in communication with each inspection station to receive information from the inspection stations relating to characteristics detected in the containers being inspected, and to determine if the characteristics detected fall within predetermined limits.

24. The apparatus of claim 23 which also includes a reject mechanism in communication with the controller and selectively activated by the controller to remove from the inspection path containers having characteristics falling outside said predetermined limits.

25. The apparatus of claim 24 wherein the controller deactivates the reject mechanism during a test cycle to prevent test containers from being processed as rejected containers.

26. The apparatus of claim 17 wherein said controller is programmable to initiate and control a test cycle at desired intervals.

27. The apparatus of claim 23 wherein the controller has an output providing information relating to the characteristics detected at the inspection stations.

28. The apparatus of claim 27 wherein the output of the controller during a test cycle includes an indication when a characteristic detected at the inspection stations differs from the known characteristics of a test container.

29. The apparatus of claim 27 which also includes a display in communication with the controller and capable of displaying at least a portion of the output of the controller.

30. The apparatus of claim 29 wherein said display is located remote from the controller.

31. The apparatus of claim 16 wherein said characteristics include at least one of commercial variations and mold indicia.

32. A method of inspecting containers for characteristics with an inspection apparatus having at least one inspection device disposed generally in an inspection path and a secondary conveyor path selectively communicated with said inspection path, said method including the steps of:
selectively providing production containers to said inspection path for inspection by said at least one inspection device;
selectively providing a plurality of test containers having known characteristics from said secondary conveyor path to said inspection path for inspection by said at least one inspection device and thereafter returning said test containers to said secondary conveyor path;
receiving from said at least one inspection device information indicative of the characteristics detected in the containers; and
correlating the information received from said at least one inspection device and relating to the test containers with the known characteristics in the test containers.

33. The method set forth in claim 32 wherein said test containers are provided to the inspection path separately from said production containers.

34. The method set forth in claim 32 wherein the inspection apparatus includes an infeed conveyor for providing production containers to the inspection path, and said step of selectively providing production containers to the inspection path is accomplished by operating the infeed conveyor when it is desired to send production containers to the inspection path and stopping the infeed conveyor when it is not desired to send production containers to the inspection path.

35. The method set forth in claim 32 wherein the inspection apparatus includes a test container conveyor for providing test containers to the inspection path, and said step of selectively providing test containers to the inspection path is accomplished by operating the test container conveyor when it is desired to send test containers to the inspection path and stopping the test container conveyor when it is not desired to send test containers to the inspection path.

36. The method set forth in claim 32 wherein the inspection apparatus includes a controller in communication with said at least one inspection device, said controller being capable of receiving said information from said at least one inspection device and correlating said information with said known characteristics.

37. The method set forth in claim 36 wherein said controller is operable to selectively provide one of the production containers and the test containers to the inspection path.

38. The method set forth in claim 37 wherein, through use of the controller, and operator selectively provides one of the production containers and the test containers to the inspection path.

39. The method set forth in claim 37 wherein the controller is programmable and selectively provides the production containers and the test containers to the inspection path in accordance with a program.

40. A method of verifying operation of a plurality of container inspection devices that inspect containers traveling in an inspection path through said devices, said method including the steps of:
(a) interrupting a flow of containers traveling in said inspection path,
(b) directing a plurality of containers from a loop parallel to said inspection path through said inspection path,
(c) inspecting said containers from said loop with at least some of said devices to obtain information indicative of characteristics found in the those containers, and
(d) directing said containers from step (c) back to said loop after inspection.

41. The method set forth in claim 40 wherein the containers in said loop are test containers having known characteristics and said method further includes the step of correlating the information obtained in said step (c) with the known characteristics in the test containers.

42. The method of claim 41 wherein the known characteristics includes at least one of commercial variations and mold indicia.

43. The method set forth in claim 40 wherein the inspection path communicates with an infeed conveyor by which production containers are fed to the inspection path, and the loop includes a test container conveyor by which test containers are fed to the inspection path during a test cycle, and said step (a) is accomplished by stopping the infeed conveyor to prevent production containers from flowing to the inspection path, and starting the test container conveyor to provide test containers to the inspection path and receive containers on the test container conveyor from the inspection path after said step of inspecting said test containers.

44. An apparatus for inspecting containers for characteristics which includes:
at least one inspection station disposed in an inspection path,
conveyors for feeding containers to and from said inspection path,
a secondary conveyor loop parallel to said inspection path and connected at one end with said inspection path upstream of said at least one inspection station and at its other end with said inspection path downstream of said at least one inspection station, and
a controller operable to selectively interrupt a flow of containers between said conveyors and said inspection path, and direct containers from said loop through said inspection path and back into said loop.

45. The apparatus of claim 44 which also includes an infeed gate connecting said one end of said loop with said inspection path and an outfeed gate connecting said other end of said loop with said inspection path, said infeed gate and said outfeed gate being operated by said controller to selectively direct containers from said loop onto said inspection path and from said inspection path back onto said loop during a test cycle.

46. The apparatus of claim 45 wherein said infeed gate includes a diverter movable between a first position wherein it does not interrupt the flow of containers in said inspection path and a second position wherein it interrupts the flow of containers in said inspection path and permits the flow of containers from said secondary conveyor loop into said inspection path.

47. The apparatus of claim 45 wherein said outfeed gate includes a diverter movable between a first position wherein it does not interrupt the flow of containers from said inspection path to an outfeed conveyor carrying containers away from said inspection path and a second position wherein it prevents the flow of containers from said inspection path to said outfeed conveyor and permits the flow of containers from said inspection path to said secondary conveyor loop.

48. The apparatus of claim 44 which also includes a drive for the secondary conveyor that is selectively operated by said controller to move containers on said secondary conveyor toward said inspection path and deactivated by the controller to prevent containers on said secondary conveyor from moving to said inspection path.

49. The apparatus of claim 44 wherein said conveyors for feeding containers include an infeed conveyor that feeds containers to the inspection path and an infeed conveyor drive, said infeed conveyor drive being selectively disabled by the controller to prevent sending containers from the infeed conveyor to the inspection path during a test cycle.

50. The apparatus of claim 44 wherein the controller is in communication with each inspection station to receive information from the inspection stations relating to characteristics detected in the containers being inspected, and to determine if the characteristics detected fall within predetermined limits.

51. The apparatus of claim 44 wherein test containers having known characteristics are disposed on said secondary conveyor loop, and said controller correlates the output of the inspection device obtained from inspection of said test containers with the known characteristics of the test containers.

52. The apparatus of claim 51 wherein said known characteristics include at least one of commercial variations and mold indicia.
